(19) United States
(12) Patent Application Publication
(10) Pub. No.: US 2018/0202709 A1
(43) Pub. Date: Jul. 19, 2018

(54) REFRIGERATOR AND CAMERA SYSTEM THEREOF

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIA-HUNG CHEN, New Taipei (TW); LIANG XIE, Shenzhen (CN); SHUN-CHUAN YANG, New Taipei (TW)

(21) Appl. No.: 15/450,176

(22) Filed: Mar. 6, 2017

(30) Foreign Application Priority Data
Jan. 18, 2017 (CN) 201710038340.7

(51) Int. Cl. F25D 29/00; F25D 23/02; H04N 7/18; H04N 5/265

(52) U.S. Cl. CPC F25D 29/005; F25D 23/028; F25D 2400/36; H04N 5/265; F25D 2700/06; H04N 7/181

(57) ABSTRACT

The present disclosure discloses a refrigerator. The refrigerator comprises a main body, at least one door connecting to the main body, and a camera system disposed on the door. The main body comprises a plurality of compartments for storing food. The camera system comprises a plurality of camera modules respectively facing the plurality of compartments. Each of the camera modules comprises a first camera unit and a second camera unit to take at least one image of the corresponding compartment.

### CROSS-REFERENCE TO RELATED APPLICATIONS

This application claims priority to Chinese Invention Patent Application No. 201710038340.7 filed on Jan. 18, 2017, the contents of which are incorporated by reference herein.

### FIELD

The present disclosure generally relates to a refrigerator. More particularly, the present disclosure relates to a refrigerator having a camera system and the camera system thereof.

### BACKGROUND

As technologies further develops, users require more functions on a refrigerator.

Currently, when there is a need to check the food item stored in a refrigerator, users need to open its door. Opening a refrigerator's door may cause leakage of cool air and therefore consume electricity. Also, users tend to buy a lot of food item to store in the refrigerator and then usually forget what they have bought until the food item expires or goes bad to produce odor. Moreover, if the space of the refrigerator is occupied by too much food, the cooling cycle of the refrigerator becomes inefficient. A current solution is to provide a camera in the refrigerator. The camera can take images of the food item stored in the refrigerator and send the image to user. In FIG. 1, a partial view of a compartment of a refrigerator 100 with a camera device 110 of a conventional technology is illustrated. As shown in FIG. 1, the conventional camera device 110 is disposed on the wall of the compartment. However, the refrigerator 100 usually has a plurality of compartments. The conventional camera device 110 cannot take image of every compartment. Furthermore, since the conventional camera device 110 is disposed on the wall of the compartment to take images in a direction away from the interior of the refrigerator, the camera device 110 can only take images of the food item that is stored on the refrigerator's door, and therefore cannot take image of the food item that is stored in the compartments.

In order to solve the above problems, there is a need to provide a refrigerator that allows users to easily check the food item therein, and hence to efficiently manage food inventory to avoid waste.

### SUMMARY OF THE INVENTION

In view of above, the object of the present disclosure is to provide a refrigerator and camera system thereof. The camera system of the present disclosure is disposed on an inner side of the door of the refrigerator. For each compartment of the refrigerator, the camera system of the present disclosure uses two camera units respectively taking images of a left portion and a right portion of the compartment. Users can clearly check the food item stored in every compartment without opening the door of the refrigerator.

To achieve the above object, the present disclosure discloses a refrigerator comprising a main body, at least one door connecting to the main body, and a camera system disposed on the door. The main body comprises a plurality of compartments for storing food. The camera system comprises a plurality of camera modules respectively facing the plurality of compartments. Each of the camera modules comprises a first camera unit and a second camera unit to take at least one image of the corresponding compartment.

To achieve the above object, the present disclosure discloses a camera system for a refrigerator. The refrigerator comprises a main body and at least one door connecting to the main body. The main body comprises a plurality of compartments for storing food. The camera system of the present disclosure is disposed on the door. The camera system comprises a plurality of camera modules respectively facing the plurality of compartments. Each of the camera modules comprises a first camera unit and a second camera unit to take at least one image of the corresponding compartment.

To achieve the above object, the present disclosure discloses a food management method for a refrigerator. The food management method provides a camera system in the refrigerator. The refrigerator comprises a main body and at least one door connecting to the main body. The main body comprises a plurality of compartments. The door comprises an inner surface and an outer surface. The food management method of the present disclosure comprises steps of:

Step S01: Providing a transmission module in the refrigerator.

Step S02: Disposing a camera system and an image processing module on the door of the refrigerator to connect to the transmission module; wherein the camera system comprises a plurality of camera modules respectively facing the plurality of compartments. Each of the camera modules comprises a first camera unit and a second camera unit to take at least one image of the corresponding compartment.

Step S03: After closing the door of the refrigerator, obtaining images of the plurality of compartments respectively by the first camera units and the second camera units.

Step S04: Processing the images taken by the first camera unit and the second camera unit to form a combined image.

Step S05: Transmitting the combined images of the plurality of compartments to a display device by the transmission module.

In one exemplary embodiment, the first camera unit and the second camera unit have an angle of view greater than or equal to 88 degrees.

In one exemplary embodiment, the main body comprises a first wall and a second wall. The door comprises a first side and a second side. The first wall of the main body and the first side of the door are connected by a shaft.

In one exemplary embodiment, the door comprises an inner surface and an outer surface. When the door is closed, the inner surface of the door faces to the plurality of compartments. The plurality of camera modules is disposed on the inner surface of the door.

In one exemplary embodiment, the inner surface of the door comprises a first protrusion rib adjacent to the first side, and a second protrusion rib adjacent to the second side. The first camera units of the plurality of the camera modules are disposed along a longitudinal direction of the first protrusion rib. The second camera units of the plurality of the camera modules are disposed along a longitudinal direction of the second protrusion rib.

In one exemplary embodiment, the first camera units and the second camera units are disposed with a left tilting angle with respect to the corresponding compartments.

In one exemplary embodiment, the left tilting angle of the first camera units is greater than the left tilting angle of the second camera units.

In one exemplary embodiment, the left tilting angle of the first camera units is 45 degrees. The left tilting angle of the second camera units is 20 to 30 degrees.

In one exemplary embodiment, the at least one door comprises a first door and a second door. A width of the first door is greater that a width of the second door. The plurality of camera modules is disposed on the first door.

In one exemplary embodiment, the refrigerator further comprises an image processing module and a transmission module; the image processing module processes the images taken by the first camera unit and the second camera unit to form a combined image; and the transmission module transmits the combined image to a mobile device.

As described above, the refrigerator, the camera system, and the food management method thereof of the present disclosure use two camera units respectively taking images of a left portion and a right portion of each compartment of the refrigerator. In addition, the refrigerator of the present disclosure further comprises an image processing module to process the images of the two camera units to form a combined image of the corresponding compartment. The combined image is transmitted by a transmission module to a mobile device or a display module that is disposed on an outer surface of the door of the refrigerator. Therefore, users can easily and clearly check the food item stored in the refrigerator without opening the door or even from a remote place.

### BRIEF DESCRIPTION OF THE DRAWINGS

Implementations of the present technology will now be described, by way of example only, with reference to the attached figures.

FIG. 1 is a perspective view of a conventional camera device for a refrigerator.

FIGS. 2A and 2B are front views of a refrigerator of the present disclosure.

FIG. 2A is a front view of the refrigerator assembled.

FIG. 2B is an exploded front view of the refrigerator.

FIG. 3 is a perspective view of the door of a refrigerator and a camera system of the present disclosure.

FIG. 4 is an enlarged view of part of the door of the refrigerator and camera modules of the present disclosure.

FIG. 5 is a perspective view of the images taken by a first camera unit and a second camera unit.

FIG. 6 is a flow chart of a food management method for the refrigerator of the present disclosure.

### DETAILED DESCRIPTION

The present disclosure will now be described more fully hereinafter with reference to the accompanying drawings, in which exemplary embodiments of the disclosure are shown. This disclosure may, however, be embodied in many different forms and should not be construed as limited to the exemplary embodiments set forth herein. Rather, these exemplary embodiments are provided so that this disclosure will be thorough and complete, and will fully convey the scope of the disclosure to those skilled in the art. Like reference numerals refer to like elements throughout.

The terminology used herein is for the purpose of describing particular exemplary embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

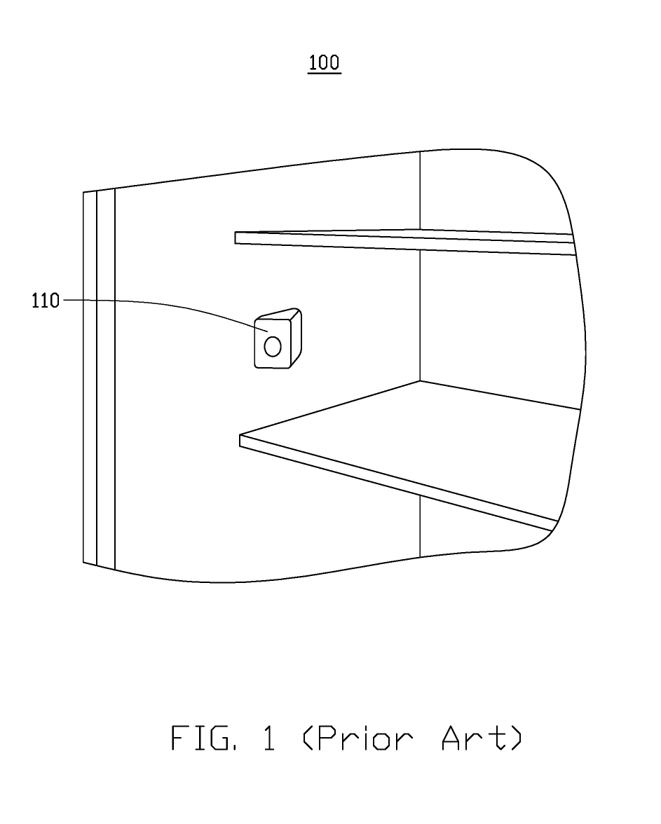

The description will be made as to the exemplary embodiments of the present disclosure in conjunction with the accompanying drawings in FIGS. 1 to 6. Reference will be made to the drawing figures to describe the present disclosure in detail, wherein depicted elements are not necessarily shown to scale and wherein like or similar elements are designated by same or similar reference numeral through the several views and same or similar terminology.

The present disclosure will be further described hereafter in combination with figures.

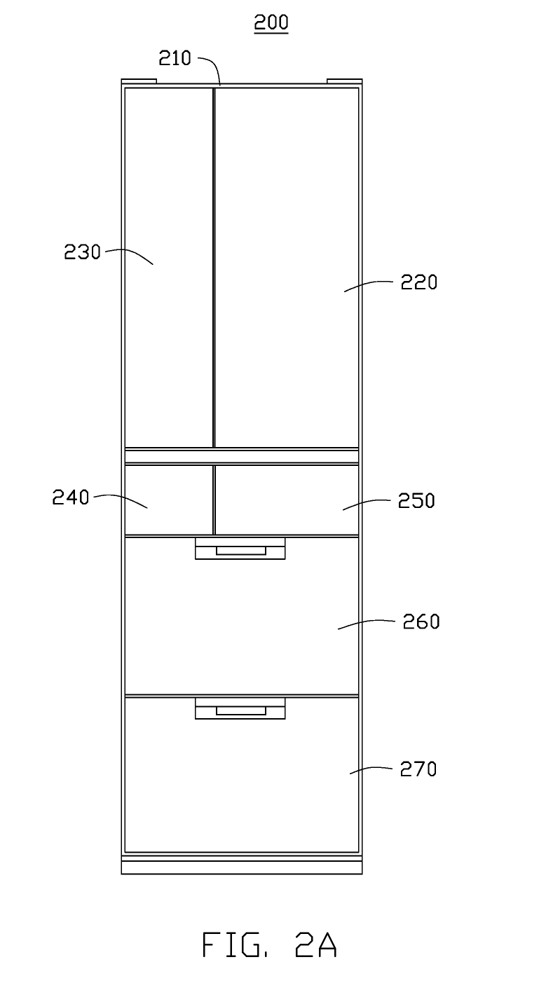

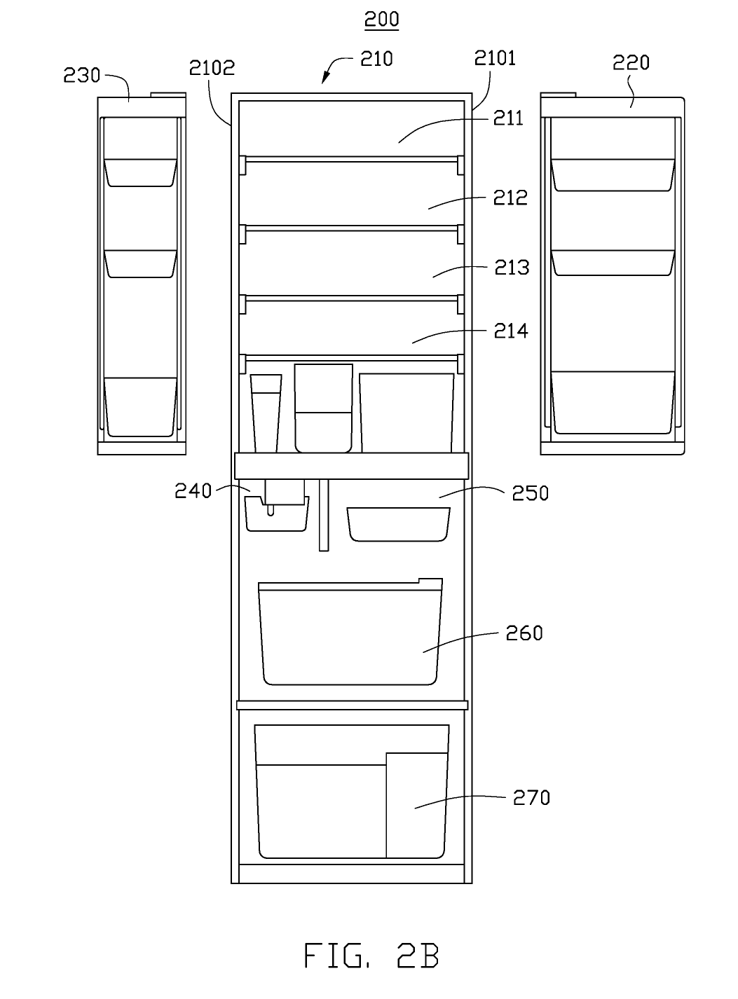

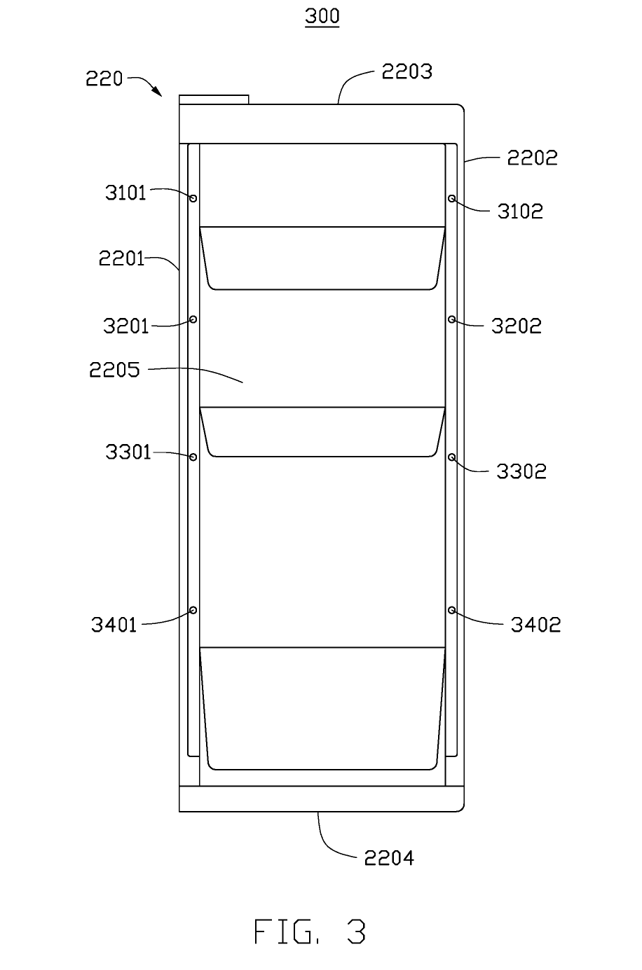

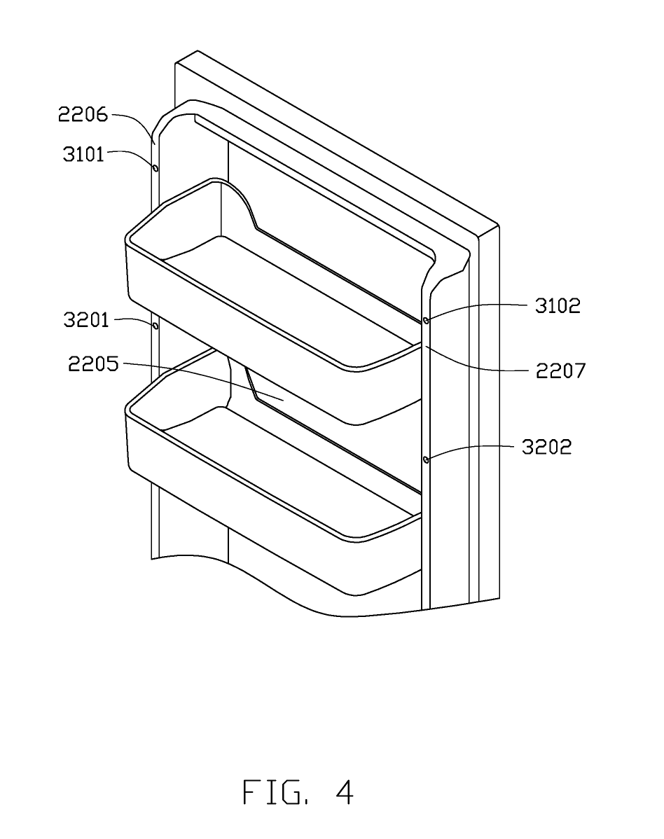

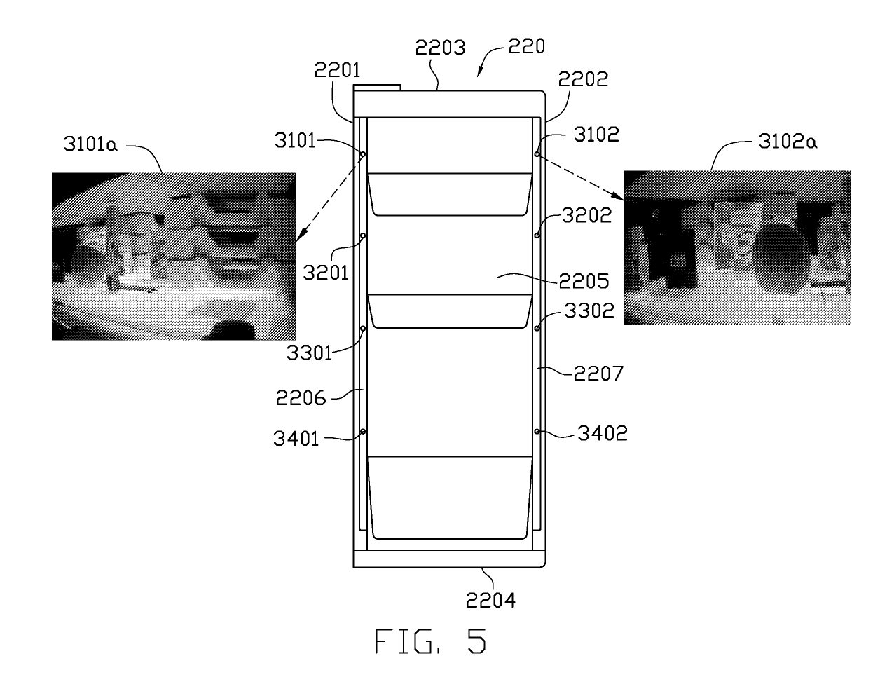

Referring to FIGS. 2A, 2B, and 3, the refrigerator 200 according to an exemplary embodiment of the present disclosure comprises a main body 210, a first door 220, a second door 230, and a camera system 300. The first door 220 and the second door 230 respectively connect to the main body 210 by a shaft (not shown in the figures). In this exemplary embodiment, the refrigerator 200 of the present disclosure is illustrated by a six-door refrigerator, but not limited thereto. In FIGS. 2A and 2B, the refrigerator 200 further comprises a first drawer 240, a second drawer 250, a third drawer 260, and a fourth drawer 270. The structures of the main body and the drawer of a six-door refrigerator may have the design similar to the conventional refrigerator, but not limited thereto. The main body 210 comprises a plurality of compartments for storing food. In this exemplary embodiment, the main body 210 comprises four compartments, which are a first compartment 211, a second compartment 212, a third compartment 213, and a fourth compartment 214. The plurality of compartments 211, 212, 213, 214 is disposed in the main body 210 along a longitudinal direction of the main body 210. When the first door 220 and the second door 230 are closed, the first door 220 and the second 230 are facing the compartments 211, 212, 213, 214 to cover the compartments 211, 212, 213, 214 and forming an enclosed space. When users need to take food out from the compartments 211, 212, 213, 214, they can open the first door 220, or the second door 230, or both of the first door 220 and second door 230. After taking out food, users can close the first door 220 and the second door 230 to prevent cool air leakage from the compartments 211, 212, 213, 214. In this exemplary embodiment, a width of the first door 220 is greater than a width of the second door 230.

The main body 210 comprises a first wall 2101 and a second wall 2102. The first wall 2101 and the 2102 are parallel to each other. The first door 220 has a shape of a rectangle. The first door 220 comprises a first side 2201, a second side 2202, a third side 2203, and a fourth side 2204. The first side 2201 and the second side 2202 are parallel to each other. The third side 2203 and the fourth side 2204 are parallel to each other. The first side 2201 is perpendicular to the third side 2203 and the fourth side 2204. The second side 2202 is perpendicular to the third side 2203 and the fourth side 2204. The first side 2201 of the first door 220 is connected to the first wall 2101 of the main body 210 through a shaft (not shown in the figures). When users apply a pulling force on the second side 2202 of the first door 220, the second side 2202 of the first door 220 moves away from the compartments 211, 212, 213, 214, and therefore the first door 220 is opened.

Referring to FIG. 3, the first door 220 comprises an inner surface 2205 and an outer surface (not shown in the figures). When the first door 220 is closed, the inner surface 2205 is facing the plurality of compartments 211, 212, 213, 214. The camera system 300 comprises a plurality of cameras modules. In this exemplary embodiment, the camera system 300 comprises a first camera module 310, a second camera module 320, a third camera module 330, and a fourth camera module 340. The first camera module 310 comprises a first camera unit 3101 and a second camera unit 3102; the second camera module 320 comprises a first camera unit 3201 and a second camera unit 3202; the third camera module 330 comprises a first camera unit 3301 and a second camera unit 3302; and the fourth camera module 340 comprises a first camera unit 3401 and a second camera unit 3402. The plurality of camera modules 310, 320, 330, 340 is disposed on the inner surface 2205 of the first door 220, and respectively facing the plurality of compartments 211, 212, 213, 214. In other words, the first camera units 3101, 3201, 3301, 3401 and the second camera units 3102, 3202, 3302, 3402 are disposed on the inner surface 2205 of the first door 220. When the first door 220 is closed, the first camera unit 3101 and the second camera unit 3102 of the first camera module 310 take at least one image of the first compartment 211; the first camera unit 3201 and the second camera unit 3202 of the second camera module 320 take at least one image of the second compartment 212; the first camera unit 3301 and the second camera unit 3302 of the third camera module 330 take at least one image of the third compartment 213; and the first camera unit 3401 and the second camera unit 3402 of the fourth camera module 340 take at least one image of the fourth compartment 214.

In addition, the first camera units 3101, 3201, 3301, 3401 and the second camera units 3102, 3202, 3302, 3402 have an angle of view (or field of view, FOV) greater than or equal to 88 degrees. In this exemplary embodiment, the angle of view of the first camera units 3101, 3201, 3301, 3401 and the second camera units 3102, 3202, 3302, 3402 is 180 degrees.

Referring to FIG. 4, the inner surface 2205 of the first door 220 comprises a first protrusion rib 2206 and a second protrusion rib 2207. The first protrusion rib 2206 is parallel to the first side 2201 and the second side 2202, and adjacent to the first side 2201. The second protrusion rib 2207 is parallel to the first side 2201 and the second side 2202, and adjacent to the second side 2202. The first camera units 3101, 3201, 3301, 3401 are disposed along a longitudinal direction of the first protrusion rib 2206, and are arranged perpendicular to the third side 2203 and the fourth side 2204. The second camera units 3102, 3202, 3302, 3402 are disposed along a longitudinal direction of the second protrusion rib 2207, and are arranged perpendicular to the third side 2203 and the fourth side 2204.

In this exemplary embodiment, the refrigerator 200 comprises a first door 220 and a second door 230. As shown in FIG. 2A, a front view of the refrigerator 200 is illustrated. When the first door 220 and the second door 230 are closed, the inner surface 2205 of the first door 220 is facing a right portion of the compartments 211, 212, 213, 214; and the inner surface of the second door 230 is facing a left portion of the compartments 211, 212, 213, 214. The first camera units 3101, 3201, 3301, 3401 and the second camera units 3102, 3202, 3302, 3402 are disposed on the inner surface 2205 of the first door 220. In order to take images of the left portion of the compartments 211, 212, 213, 214 covered by the second door 230, the first camera units 3101, 3201, 3301, 3401 and the second camera units 3102, 3202, 3302, 3402 are disposed with a left tilting angle with respect to the corresponding compartments. In addition, the left tilting angle of the first camera units 3101, 3201, 3301, 3401 is greater than the left tilting angle of the second camera units 3102, 3202, 3302, 3402. In a preferred exemplary embodiment, the left tilting angle of the first camera units 3101, 3201, 3301, 3401 is 45 degrees; and the left tilting angle of the second camera units 3102, 3202, 3302, 3402 is 20 to 30 degrees.

The refrigerator 200 of the present disclosure further comprises a transmission module (not shown in the figures). In a preferred exemplary embodiment, the transmission module is a Wi-Fi module, but not limited thereto. The transmission module is connected to the camera system 300 to transmit the images of the compartments 211, 212, 213, 214 taken by the first camera units 3101, 3201, 3301, 3401 and the second camera units 3102, 3202, 3302, 3402 to a remote device (not shown in the figures). Users can easily check the food item stored in the refrigerator without opening the door or even from a remote place. The remote device can be a mobile device or a remote server.

The refrigerator 200 of the present disclosure further comprises an image processing module (not shown in the figures). The image processing module processes the images taken by the first camera units 3101, 3201, 3301, 3401 and the second camera units 3102, 3202, 3302, 3402 to form combined images of the corresponding compartments 211, 212, 213, 214. For example, the image processing module processes the images taken by the first camera unit 3101 and the second camera unit 3102 of the first camera module 310 to form a combined image of the first compartment 211. The transmission module transmits the combined image to a user's mobile device or a remote sever.

In another exemplary embodiment, the image processing module is located in a remote server. For example, after the remote server receives the images transmitted by the transmission module, the image processing module processes the images taken by the first camera unit 3101 and the second camera unit 3102 to form a combined image of the first compartment 211. The remote server transmits the combined image of the first compartment 211 to a user's mobile device.

In a preferred exemplary embodiment, the refrigerator 200 of the present disclosure further comprises a display module (not shown in the figures). The display module is disposed on an outer surface (not shown in the figures) of the first door 220 or the second door 230, and connected to the camera system 300. The display module displays the images of the compartments 211, 212, 213, 214 taken by the first camera units 3101, 3201, 3301, 3401 and the second camera units 3102, 3202, 3302, 3402. Alternatively, after the image processing module of the refrigerator 200 processes the images taken by the first camera units 3101, 3201, 3301, 3401 and the second camera units 3102, 3202, 3302, 3402 to form combined images of the compartments 211, 212, 213, 214, the display module displays the combined images. Therefore, users can easily check the food item stored in the compartments from the display module without opening the door.

Taking the compartment 211 as an example, as shown in FIG. 5, image 3101a is an image of the right portion of the first compartment 211 taken by the first camera unit 3101 of the first camera module 310; and image 3102a is an image of the left portion of the first compartment 211 taken by the second camera unit 3102 of the first camera module 310. The first camera unit 3101 and the second camera unit 3102 of the first camera module 310 may have an overlapped shooting range. The image processing module can process the images 3101a and 3102a to form a combined image that can completely show the food item stored in the first compartment 211. Similarly, the combined images of other compartments 212, 213, 214 can be obtained. The combined images are transmitted by the transmission module to a user's mobile device or directly displayed on the display module located on the outer surface of the first door 220 or the second door 230. Therefore, users can easily check the food item stored in the refrigerator without opening the door or even from a remote place. For example, when the user is shopping in a super market, the user can check the images taken by the camera system of the present disclosure through a mobile phone to check if the food item has already been purchased to avoid redundant purchasing of the food item.

Also, the present disclosure provides a camera system for a refrigerator. The refrigerator comprises a main body and at least one door connecting to the main body. The main body comprises a plurality of compartments. The door comprises an inner surface and an outer surface. The camera system of the present disclosure is disposed on the inner surface of the door. The camera system comprises a plurality of camera modules respectively facing the plurality of compartments. In addition, each of the camera modules comprises a first camera unit and a second camera unit to take at least one image of the corresponding compartment. In a preferred exemplary embodiment, the first camera unit and the second camera unit have an angle of view greater than or equal to 88 degrees. The first camera units and the second camera units are disposed with a left tilting angle with respect to the corresponding compartments. The left tilting angle of the first camera units is 45 degrees; and the left tilting angle of the second camera units is 20 to 30 degrees. The camera system of the present disclosure uses two camera units respectively taking images of a left portion and a right portion for each compartment of the refrigerator. Users can clearly check the food item stored in every compartment without opening the door of the refrigerator. The details of the camera system and the refrigerator can be referred to above-mentioned exemplary embodiments without further description.

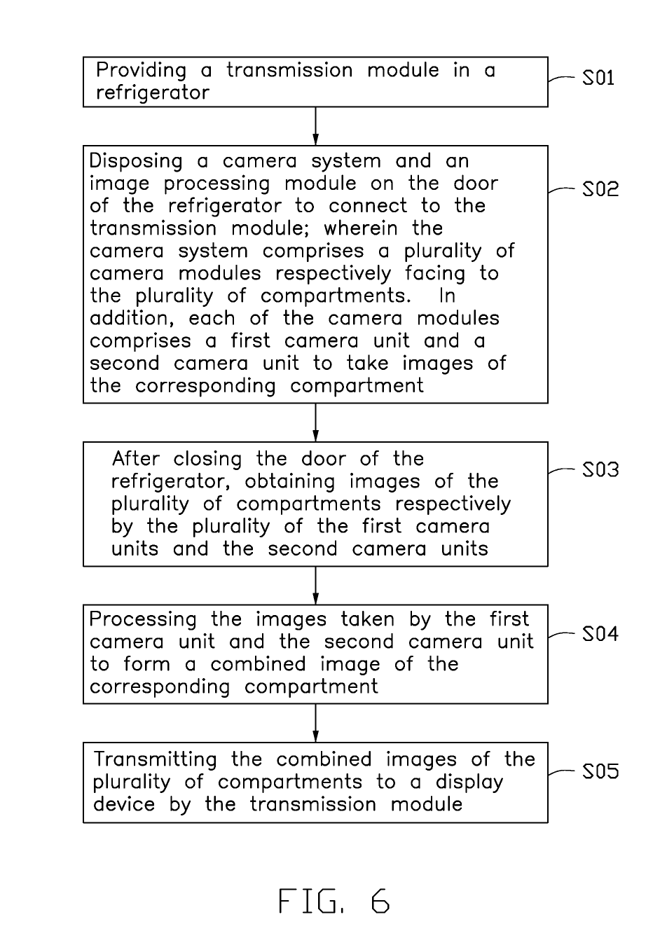

Moreover, the present disclosure provides a food management method for a refrigerator. The food management method provides a camera system in the refrigerator. The refrigerator comprises a main body and at least one door connecting to the main body. The main body comprises a plurality of compartments. The door comprises an inner surface and an outer surface. As shown in FIG. 6, the food management method of the present disclosure comprises steps of:

Step S01: Providing a transmission module in the refrigerator.

Step S02: Disposing a camera system and an image processing module on the door of the refrigerator to connect to the transmission module; wherein the camera system comprises a plurality of camera modules respectively facing the plurality of compartments. In addition, each of the camera modules comprises a first camera unit and a second camera unit to take at least one image of the corresponding compartment. In a preferred exemplary embodiment, the first camera units and the second camera units have an angle of view greater than or equal to 88 degree. The first camera units and the second camera units are disposed with a left tilting angle with respect to the corresponding compartments. The left tilting angle of the first camera units is 45 degrees; and the left tilting angle of the second camera units is 20 to 30 degrees.

Step S03: After closing the door of the refrigerator, obtaining images of the plurality of compartments respectively by the plurality of the first camera units and the second camera units.

Step S04: Processing the images taken by the first camera unit and the second camera unit to form a combined image of the corresponding compartment.

Step S05: Transmitting the combined images of the plurality of compartments to a display device by the transmission module. The display device can be a mobile device, or a display module that is disposed on the outer surface of the door of the refrigerator.

As described above, the refrigerator, the camera system, and the food management method thereof of the present disclosure use two camera units respectively taking images of a left portion and a right portion of each compartment of the refrigerator. In addition, the refrigerator of the present disclosure further comprises an image processing module to process the images of the two camera units to form a combined image of the corresponding compartment. The combined image is transmitted by a transmission module to a mobile device or a display module that is disposed on an outer surface of the door of the refrigerator. Therefore, users can easily and clearly check the food item stored in the refrigerator without opening the door or even from a remote place.

The embodiments shown and described above are only examples. Many details are often found in the art such as the other features of a refrigerator and camera system thereof. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A refrigerator, comprising:
a main body comprising a plurality of compartments for storing food;
at least one door connecting to the main body; and
a camera system disposed on the door;
wherein the camera system comprises a plurality of camera modules respectively facing the plurality of compartments; and each of the camera modules comprises a first camera unit and a second camera unit to take at least one image of the corresponding compartment.

2. The refrigerator of claim 1, wherein the first camera unit and the second camera unit have an angle of view greater than or equal to 88 degrees.

3. The refrigerator of claim 1, wherein the main body comprises a first wall and a second wall; the door comprises a first side and a second side; and the first wall of the main body and the first side of the door are connected by a shaft.

4. The refrigerator of claim 3, wherein the door comprises an inner surface and an outer surface; when the door is closed, the inner surface of the door is facing the plurality of compartments; and the plurality of camera modules is disposed on the inner surface of the door.

5. The refrigerator of claim 4, wherein the inner surface of the door comprises a first protrusion rib adjacent to the first side, and a second protrusion rib located close to the second side; the first camera units of the plurality of the camera modules are disposed along a longitudinal direction of the first protrusion rib; and the second camera units of the plurality of the camera modules are disposed along a longitudinal direction of the second protrusion rib.

6. The refrigerator of claim 5, wherein the first camera units and the second camera units are disposed with a left tilting angle with respect to the corresponding compartments.

7. The refrigerator of claim 6, wherein the left tilting angle of the first camera units is greater than the left tilting angle of the second camera units.

8. The refrigerator of claim 7, wherein the left tilting angle of the first camera units is 45 degrees; and the left tilting angle of the second camera units is 20 to 30 degrees.

9. The refrigerator of claim 1, wherein the at least one door comprises a first door and a second door; a width of the first door is greater that a width of the second door; and the plurality of camera modules is disposed on the first door.

10. The refrigerator of claim 1, further comprises an image processing module and a transmission module; the image processing module processes the images taken by the first camera unit and the second camera unit to form a combined image; and the transmission module transmits the combined image to a mobile device.
